(19) United States
(12) Patent Application Publication
(10) Pub. No.: US 2026/0243948 A1
(43) Pub. Date: Aug. 20, 2026

(54) OPTICAL FIBER

(71) Applicant: SUMITOMO ELECTRIC INDUSTRIES, LTD., Osaka (JP)

(72) Inventors: Noriaki IWAGUCHI, Osaka (JP); Tatsuya KONISHI, Osaka (JP)

(21) Appl. No.: 19/472,215

(22) PCT Filed: Apr. 9, 2024
(86) PCT No.: PCT/JP2024/014417

§ 371 Date: Oct. 3, 2025

(30) Foreign Application Priority Data
Apr. 28, 2023 (JP) 2023-074355

(51) Int. Cl. G02B 6/02; C03C 25/105; C09D 4/00; C09D 7/63; C09D 175/16

(52) U.S. Cl. CPC G02B 6/02395; C03C 25/105; C09D 4/00; C09D 7/63; C09D 175/16

(57) ABSTRACT

An optical fiber comprises a glass fiber including a core and a cladding and a coating resin layer being in contact with the glass fiber and coating the glass fiber, wherein the coating resin layer includes a primary resin layer coating the glass fiber and a secondary resin layer coating the primary resin layer, the primary resin layer includes a cured product of a resin composition containing a photopolymerization initiator, a silane coupling agent, an organic base, and a photopolymerizable compound including urethane (meth)acrylate, and a content of the organic base is 5 ppm or more and 9000 ppm or less with respect to a total amount of the coating resin layer.

### TECHNICAL FIELD

The present disclosure relates to an optical fiber. This application claims priority based on Japanese Patent Application No. 2023-074355 filed on Apr. 28, 2023, the entire contents of which are incorporated herein by reference.

### BACKGROUND ART

In general, an optical fiber includes a coating resin layer for protecting a glass fiber which transmits optical signals. The coating resin layer has, for example, a primary resin layer in contact with the glass fiber and a secondary resin layer formed on an outer peripheral surface of the primary resin layer. In order to reduce an increase in transmission loss caused by microbending generated when a lateral pressure is applied to the optical fiber, it is required to improve the lateral pressure characteristics of the optical fiber.

In order to improve the lateral pressure characteristics, it has been studied to decrease a Young's modulus of the primary resin layer or to increase a Young's modulus of the secondary resin layer. For example, in Patent literature 1, achievement of both softness (low Young's modulus) and mechanical strength of a primary resin layer has been investigated using a resin composition containing a urethane oligomer obtained by reacting a reaction product of an aliphatic polyether diol and a diisocyanate with a monohydric alcohol and hydroxyl group-containing (meth)acrylate.

### CITATION LIST

### Patent Literature

Patent literature 1: JP 2012-111674 A

### SUMMARY OF INVENTION

An optical fiber according to one aspect of the present disclosure includes a glass fiber including a core and a cladding, and a coating resin layer being in contact with the glass fiber and coating the glass fiber. The coating resin layer includes a primary resin layer coating the glass fiber and a secondary resin layer coating the primary resin layer. The primary resin layer includes a cured product of a resin composition containing a photopolymerization initiator, a silane coupling agent, an organic base, and a photopolymerizable compound including urethane (meth)acrylate. A content of the organic base is 5 ppm or more and 9000 ppm or less with respect to a total amount of the coating resin layer.

### BRIEF DESCRIPTION OF DRAWINGS

FIG. 1 is a schematic cross-sectional view showing an example of an optical fiber according to the present embodiment.

FIG. 2 is a schematic cross-sectional view showing an example of an optical fiber according to the present embodiment.

### DESCRIPTION OF EMBODIMENTS

### Problems to be Solved by Present Disclosure

An optical fiber is required to have maintained properties such as strength even in the case of being immersed in water for a long term. However, an optical fiber including a primary resin layer having low Young's modulus tends to have a low degree of curing, and when the optical fiber is immersed in hot water, the coating resin layer may peel off from the glass fiber, resulting in a decrease in the strength of the optical fiber.

An object of the present disclosure is to provide an optical fiber having excellent hot water resistance and capable of maintaining strength even when immersed in water for a long time.

### Advantageous Effects of Present Disclosure

According to the present disclosure, an optical fiber having excellent hot water resistance and capable of maintaining strength even when immersed in water for a long time can be provided.

### DESCRIPTION OF EMBODIMENTS OF PRESENT DISCLOSURE

First, the contents of the embodiments of the present disclosure will be listed and described.

(1) An optical fiber according to an embodiment of the present disclosure includes a glass fiber including a core and a cladding, and a coating resin layer being in contact with the glass fiber and coating the glass fiber. The coating resin layer includes a primary resin layer coating the glass fiber and a secondary resin layer coating the primary resin layer. The primary resin layer includes a cured product of a resin composition containing a photopolymerization initiator, a silane coupling agent, an organic base, and a photopolymerizable compound including urethane (meth)acrylate. A content of the organic base is 5 ppm or more and 9000 ppm or less with respect to a total amount of the coating resin layer.

Such an optical fiber has excellent hot water resistance by containing a specific amount of the organic base in the primary resin layer directly coating the glass fiber, and can maintain strength even when immersed in water for a long time.

(2) In the above (1), from the viewpoint of more excellent hot water resistance, the organic base may be at least one selected from the group consisting of an aromatic amine, an aliphatic amine having an aromatic ring, a heterocyclic amine, and a cyclic amide.
(3) In the above (2), from the viewpoint of further improving the hot water resistance, the cyclic amide may be 6-valerolactam or F-caprolactam.
(4) In any one of the above (1) to (3), from the viewpoint of enhancing the adhesion of the primary resin layer to the glass fiber, the resin composition may contain two or more silane coupling agents.
(5) In any one of the above (1) to (4), from the viewpoint of excellent lateral pressure characteristics, the primary resin layer may have a Young's modulus of 0.6 MPa or less at 23° C.

### Details of Embodiments of Present Disclosure

Specific examples of an optical fiber and an optical fiber ribbon according to an embodiment of the present disclosure will be described with reference to the drawings as necessary. It should be noted that the present disclosure is not limited to these examples, but is defined by the scope of the claims and is intended to include all modifications within the meaning and scope equivalent to the scope of the claims. In the following description, the same elements are denoted by the same reference numerals in the description of the drawings, and redundant description is omitted. In the present embodiment, the term “(meth)acrylate” means acrylate or methacrylate corresponding thereto, and the same applies to other similar expressions such as (meth)acrylic acid. In the present specification, ppm represents a mass ratio.

### (Optical Fiber)

The optical fiber according to the present embodiment includes the glass fiber including the core and the cladding, and the coating resin layer that is in contact with the glass fiber and coats the glass fiber. The coating resin layer includes the primary resin layer coating the glass fiber and the secondary resin layer coating the primary resin layer, and the primary resin layer includes the cured product of the resin composition containing a photopolymerization initiator, a silane coupling agent, an organic base, and a photopolymerizable compound including urethane (meth)acrylate. The content of the organic base is 5 ppm or more and 9000 ppm or less with respect to the total amount of the coating resin layer.

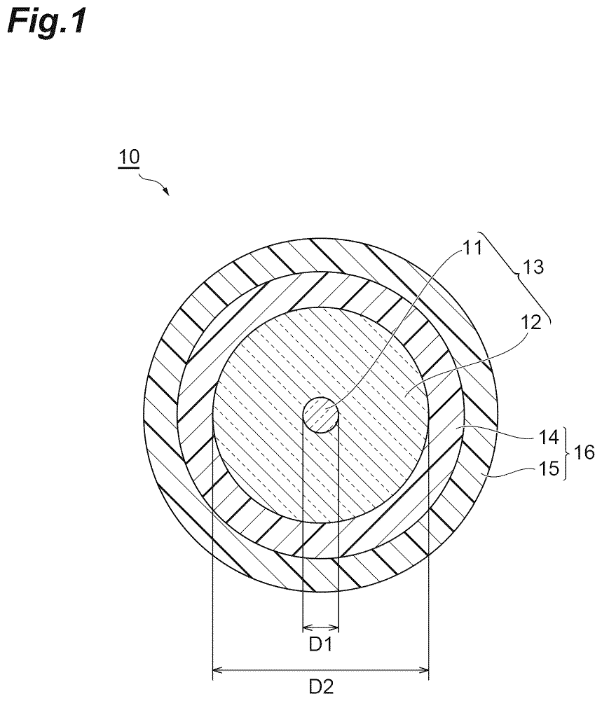

FIG. 1 is a schematic cross-sectional view showing an example of an optical fiber according to the present embodiment. An optical fiber 10 includes a glass fiber 13 including a core 11 and a cladding 12, and a coating resin layer 16 including a primary resin layer 14 provided on an outer periphery of the glass fiber 13, and a secondary resin layer 15.

The cladding 12 surrounds the core 11. The core 11 and the cladding 12 mainly include glass such as silica glass, and for example, silica glass doped with germanium or pure silica glass can be used for the core 11, and silica glass doped with fluorine or pure silica glass can be used for the cladding 12.

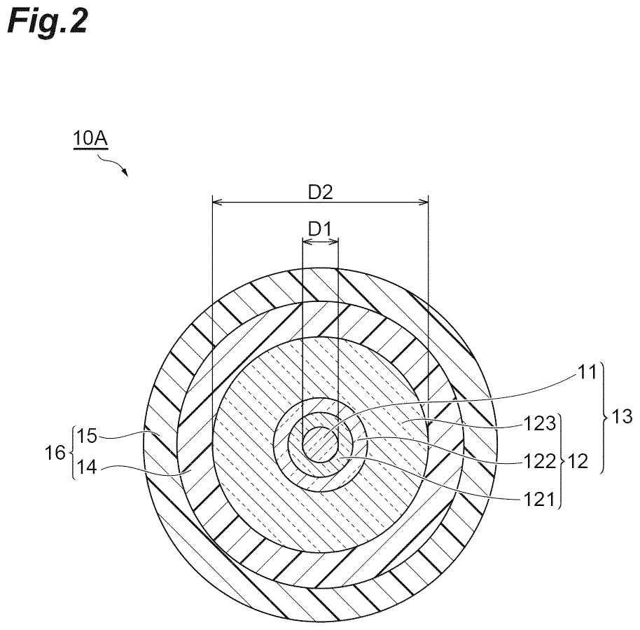

FIG. 2 is a schematic cross-sectional view showing an example of an optical fiber according to the present embodiment. In an optical fiber 10A, the cladding 12 may include an inner cladding 121 that covers an outer periphery of the core 11 and is in contact with an outer peripheral surface of the core 11, a trench 122 that covers an outer periphery of the inner cladding 121 and is in contact with an outer peripheral surface of the inner cladding 121, and an outer cladding 123 that covers an outer periphery of the trench 122 and is in contact with an outer peripheral surface of the trench 122. From the viewpoint of hot water resistance characteristics, silica glass doped with chlorine (Cl) can be used for the inner cladding 121 and the outer cladding 123. An average chlorine mass concentration is, for example, 500 ppm or more and 5000 ppm or less, or 500 ppm or more and 3000 ppm or less. Silica glass doped with fluorine can be used for the trench 122. An average OH mass concentration in the outer cladding 123 is substantially zero. Here, “substantially zero” specifically means 50 ppm or less.

In FIGS. 1 and 2, for example, an outer diameter (D2) of the glass fiber 13 may be 100 μm or more and 125 μm or less, and a diameter (D1) of the core 11 constituting the glass fiber 13 may be 7 μm or more and 15 μm or less. A thickness of the coating resin layer 16 may be, for example, 22 μm or more and 70 μm or less. A thickness of each of the primary resin layer 14 and the secondary resin layer 15 may be 5 μm or more and 50 μm or less.

The outer diameter (D2) of the glass fiber 13 may be 125 μm or more and 220 μm or less, 150 μm or more and 210 μm or less, or 170 μm or more and 190 μm or less. An outer diameter of the optical fiber 10 may be 200 μm or more and 250 μm or less, 210 μm or more and 240 μm or less, or 220 μm or more and 230 μm or less.

The primary resin layer 14 can be formed using a photopolymerizable compound including urethane (meth)acrylate, a photopolymerization initiator, a silane coupling agent, and an ultraviolet curable resin composition containing organic base.

The resin composition may contain a trace amount of an acid component such as acrylic acid derived from the photopolymerizable compound. The silane coupling agent is hydrolyzed and deactivated by the acid component, and the resin composition may change over time. In contrast, the resin composition according to the present embodiment contains the organic base, and thus, the acid component can be neutralized to suppress the deactivation of the silane coupling agent, and thus, an optical fiber having excellent hot water resistance even after a certain time has elapsed from the resin production can be produced. Such an effect is enhanced particularly when the Young's modulus of the primary resin layer is low.

As the organic base, an amine compound or an amide compound can be used. Examples of the amine compound include aromatic amines such as aniline, aliphatic amines having an aromatic ring such as benzylamine, and heterocyclic amines such as pyrrolidine, piperidine, and pyridine. Examples of the amide compound include cyclic amides such as δ-valerolactam and ε-caprolactam.

Basic components are generally known to corrode glass. When the molecular structure of the basic component is large, the corrosion reaction of the glass is less likely to occur due to the steric hindrance thereof, and thus, the organic base may be an aromatic amine, an aliphatic amine having an aromatic ring, a heterocyclic amine, or a cyclic amide. From the viewpoint of further suppressing deactivation of the silane coupling agent, the heterocyclic amine or the cyclic amide may be used as the organic base. From the viewpoint of further improving the hot water resistance, δ-valerolactam or ε-caprolactam may be used as the organic base.

A content of the organic base is 5 ppm or more and 9000 ppm or less with respect to the total amount of the coating resin layer from the viewpoint of improving the hot water resistance. A content of the organic base may be 8 ppm or more, 10 ppm or more, 100 ppm or more, 500 ppm or more, 800 ppm or more, or 1000 ppm or more, with respect to the total amount of the coating resin layer, from the viewpoint of suppressing the deactivation of the silane coupling agent, and may be 8500 ppm or less, 8000 ppm or less, 7000 ppm or less, 6000 ppm or less, or 5000 ppm or less from the viewpoint of suppressing the corrosion of glass.

The photopolymerizable compound includes urethane (meth)acrylate. As the urethane (meth)acrylate, for example, urethane (meth)acrylate obtained by reacting a polyol compound, a polyisocyanate compound, and a hydroxyl group-containing (meth)acrylate compound can be used. The urethane (meth)acrylate may be used alone or in combination of two or more kinds thereof.

Examples of the polyol compound include polytetramethylene glycol, polypropylene glycol, and bisphenol A-ethylene oxide adduct diol. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol mono(meth)acrylate.

From the viewpoint of adjusting the Young's modulus of the primary resin layer, a number-average molecular weight (Mn) of the polyol compound may be 1000 or more and 10000 or less, 1500 or more and 9000 or less, 2000 or more and 8000 or less, or 3000 or more and 6000 or less.

As a catalyst for synthesizing the urethane (meth)acrylate, an organotin compound is generally used. Examples of the organotin compound include dibutyltin dilaurate, dibutyltin diacetate, dibutyltin maleate, dibutyltin bis(2-ethylhexyl mercaptoacetate), dibutyltin bis(isooctyl mercaptoacetate), and dibutyltin oxide. From the viewpoint of availability and catalyst performance, dibutyltin dilaurate or dibutyltin diacetate may be used as the catalyst.

When the urethane (meth)acrylate is synthesized, lower alcohol having five or less carbon atoms may be used. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

From the viewpoint of adjusting the Young's modulus of the primary resin layer, a content of the urethane (meth)acrylate may be 15 parts by mass or more and 80 parts by mass or less, 20 parts by mass or more and 70 parts by mass or less, or 30 parts by mass or more and 60 parts by mass or less, with respect to 100 parts by mass of the total amount of the resin composition.

The photopolymerizable compound according to the present embodiment can further include a photopolymerizable compound (hereinafter, referred to as “monomer”) other than the urethane (meth)acrylate.

As the monomer, monofunctional monomers having one polymerizable group and polyfunctional monomers having two or more polymerizable groups can be used. A mixture of two or more monomers may be used.

Examples of monofunctional monomer include (meth)acrylate monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxydiethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxy polyethylene glycol (meth)acrylate, 2-hydroxyethyl (meth)acrylate, nonylphenol ethylene oxide-modified (meth)acrylate, tricyclodecanyl (meth)acrylate, polypropylene glycol mono(meth)acrylate, and isobornyl (meth)acrylate; carboxy group-containing monomers such as (meth)acrylic acid, (meth)acrylic acid dimer, carboxyethyl (meth)acrylate, carboxypentyl (meth)acrylate, and ω-carboxy-polycaprolactone (meth)acrylate; heterocyclic ring-containing monomers such as N-vinylpyrrolidone, N-vinyl caprolactam, N-(meth)acryloyl morpholine, N-(meth)acryloyl piperidine, N-(meth)acryloyl pyrrolidine, 3-(3-pyridine)propyl (meth)acrylate, and cyclic trimethylolpropane formal acrylate; maleimide-based monomers such as maleimide, N-cyclohexyl maleimide, and N-phenylmaleimide; amide-based monomers such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylolpropane (meth)acrylamide; aminoalkyl (meth)acrylate monomers such as aminoethyl (meth)acrylate, aminopropyl (meth)acrylate, N,N-dimethylaminoethyl (meth)acrylate, and tert-butylaminoethyl (meth)acrylate; and succinimide monomers such as N-(meth)acryloyl oxymethylene succinimide, N-(meth)acryloyl-6-oxyhexamethylene succinimide, and N-(meth)acryloyl-8-oxyoctamethylene succinimide.

From the viewpoint of excellent copolymerizability with other monomers and improvement in curing rate, an N-vinyl monomer having a cyclic structure may be used as the monofunctional monomer. A content of the N-vinyl monomer may be 1 part by mass or more and 15 parts by mass or less, or 2 parts by mass or more and 10 parts by mass or less, with respect to 100 parts by mass of the total amount of the resin composition.

Examples of the polyfunctional monomer include polyethylene glycol di(meth)acrylate, tricyclodecanediyldimethylene di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, hydroxypivalate neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-haxadecanediol di(meth)acrylate, 1,20-eicosanediol di(meth)acrylate, neopentyl glycol di(meth)acrylate, isopentyldiol di(meth)acrylate, 3-ethyl-1,8-octanediol di(meth)acrylate; trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl]isocyanurate, pentaerythritol tri(meth)acrylate, pentaerythritol polyethoxy tetra(meth)acrylate, pentaerythritol polypropoxy tetra (meth)acrylate, pentaerythritol tetra (meth)acrylate, ditrimethylolpropane tetra(meth)acrylate, dipentaerythritol tetra (meth)acrylate, dipentaerythritol penta(meth)acrylate, dipentaerythritol hexa(meth)acrylate, and caprolactone-modified tris[(meth)acryloyloxyethyl]isocyanurate.

The photopolymerizable compound according to the present embodiment may include a polyfunctional monomer modified with alkylene oxide from the viewpoint of adjusting the Young's modulus of the resin layer. The polyfunctional monomer modified with alkylene oxide may have at least one selected from the group consisting of an ethylene oxide (EO) chain and a propylene oxide (PO) chain. The ethylene oxide chain can be represented by “(EO) n”, and the propylene oxide chain can be represented by “(PO) n”. The “n” is an integer of 1 or more, may be 2 or more or 3 or more, and may be 30 or less, 25 or less, or 20 or less.

Examples of alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, and propylene oxide-modified neopentyl glycol di(meth)acrylate.

The photopolymerization initiator can be appropriately selected from known radical photopolymerization initiators and used. Examples of the photopolymerization initiator include 1-hydroxycyclohexyl phenyl ketone (Omnirad 184, manufactured by IGM Resins, B.V.), 2,2-dimethoxy-2-phenyl acetophenone, 1-(4-isopropylphenyl)-2-hydroxy-2-methylpropan-1-one, bis(2,6-dimethoxybenzoyl)-2,4,4-trimethylpentylphosphine oxide, 2-methyl-1-[4-(methylthio)phenyl]-2-morpholino-propan-1-one (Omnirad 907, manufactured by IGM Resins, B.V.), 2,4,6-trimethylbenzoyl diphenylphosphine oxide (Omnirad TPO, manufactured by IGM Resins, B.V.), and bis(2,4,6-trimethylbenzoyl)phenylphosphine oxide (Omnirad 819, manufactured by IGM Resins, B.V.).

A content of the photopolymerization initiator may be 1 part by mass or more and 10 parts by mass or less, 2 parts by mass or more and 8 parts by mass or less, or 3 parts by mass or more and 7 parts by mass or less, with respect to 100 parts by mass of the total amount of the photopolymerizable compound. The content of the photopolymerization initiator may be 0.2 parts by mass or more, 0.4 parts by mass or more, or 0.6 parts by mass or more, and may be 6 parts by mass or less, 5 parts by mass or less, or 4 parts by mass or less, with respect to 100 parts by mass of the total amount of the photopolymerizable compound.

The silane coupling agent is not particularly limited as long as it does not hinder the curing of the resin composition. Examples of the silane coupling agent include tetramethyl silicate, tetraethyl silicate, mercaptopropyl trimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyl trimethoxysilane, γ-glycidoxypropyltrimethoxysilane, γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl) propyl]tetrasulfide, bis-[3-(triethoxysilyl)propyl]disulfide, γ-trimethoxysilylpropyldimethylthiocarbamyl tetrasulfide, and γ-trimethoxysilylpropylbenzothiazyltetrasulfide. The resin composition according to the present embodiment may contain two or more silane coupling agents from the viewpoint of enhancing the adhesion of the primary resin layer to the glass fiber.

A content of the silane coupling agent may be 0.1 parts by mass or more and 5.0 parts by mass or less, 0.2 parts by mass or more and 4.0 parts by mass or less, or 0.3 parts by mass or more and 3.0 parts by mass or less, with respect to 100 parts by mass of the total amount of the resin composition.

The Young's modulus of the primary resin layer may be 0.6 MPa or less, 0.55 MPa or less, 0.5 MPa or less, or 0.4 MPa or less at 23° C. from the viewpoint of enhancing the glass strength of the optical fiber. The lower limit of the Young's modulus of the primary resin layer is not particularly limited, and may be 0.05 MPa or more, 0.1 MPa or more, or 0.2 MPa or more. The Young's modulus of the primary resin layer can be measured by a pullout modulus (POM) method at 23° C. The Young's modulus of the primary resin layer can be adjusted by the kind of urethane (meth)acrylate, the molecular weight of urethane (meth)acrylate, the kind of monomer, the blending amount of monomer, and the like.

The secondary resin layer 15 may be formed using a conventionally known resin composition for a secondary resin layer. The secondary resin layer 15 can be formed by curing a resin composition including, for example, urethane (meth)acrylate, a monomer, and a photopolymerization initiator.

The Young's modulus of the secondary resin layer 15 may be 800 MPa or more, 1000 MPa or more, or 1200 MPa or more at 23° C. from the viewpoint of further improving the hot water resistance of the optical fiber. The Young's modulus of the secondary resin layer 15 may be 2000 MPa or less, 1800 MPa or less, or 1500 MPa or less at 23° C. from the viewpoint of forming a resin layer having excellent toughness. The Young's modulus of the secondary resin layer can be measured by a tensile test of the coating resin layer. The Young's modulus of the secondary resin layer can be adjusted by the kind of urethane (meth)acrylate, the molecular weight of urethane (meth)acrylate, the kind of monomer, the blending amount of monomer, and the like.

### EXAMPLES

Hereinafter, the results of evaluation tests using examples and comparative examples according to the present disclosure will be shown, and the present disclosure will be described in more detail. Here, the present disclosure is not limited to these examples.

### [Resin Composition for Primary Resin Layer]

### (Photopolymerizable Compound)

As a photopolymerizable compound, nonylphenol EO modified acrylate (EO-NPA), 1,6-hexanediol diacrylate (1,6-HAD), isobornyl acrylate, trimethylol propane triacrylate, and urethane acrylate obtained by reacting polypropylene glycol having a molecular weight of 4000, isophorone diisocyanate, and hydroxyethyl acrylate were prepared.

### (Photopolymerization Initiator)

As a photopolymerization initiator, 2,4,6-trimethylbenzoyl diphenylphosphine oxide (TPO) was prepared.

### (Silane Coupling Agent)

As silane coupling agents, 3-mercaptopropyltrimethoxysilane (MPTS) and tetraethoxysilane (TEOS) were prepared.

### (Organic Base)

As organic bases, δ-valerolactam, ε-caprolactam, pyridine, aniline, and benzylamine were prepared.

After mixing photopolymerizable compounds, a photopolymerization initiator, and silane coupling agents in the blending amounts (parts by mass) shown in Table 1 or Table 2, an organic base was mixed so that the content in the coating resin layer was adjusted to the content (ppm) shown in Table 1 or Table 2, thereby preparing a resin composition for a primary resin layer of each test example.

### [Resin Composition for Secondary Resin Layer]

Urethane (meth)acrylate obtained by reacting polypropylene glycol having a molecular weight of 1000, isophorone diisocyanate, and 2-hydroxyethyl acrylate was prepared. A resin composition S for the secondary resin layer was prepared by mixing 60 parts by mass of the urethane (meth)acrylate, 19 parts by mass of isobornyl acrylate, 20 parts by mass of trimethylol propane triacrylate, and 1 part by mass of 2,4,6-trimethylbenzoyl diphenylphosphine oxide.

### [Production of Optical Fiber]

A primary resin layer having a thickness of 17.5 μm was formed on an outer periphery of the glass fiber having a diameter of 125 μm and constituted by a core and a cladding using the resin composition of each of test examples 1 to 11, and a secondary resin layer having a thickness of 15 μm was further formed on the outer periphery thereof using the resin composition S, thereby producing an optical fiber. Test examples 1 to 9 correspond to examples, and test examples 10 and 11 correspond to comparative examples.

### (Young's Modulus of Primary Resin Layer)

The Young's modulus of the primary resin layer was measured by POM method at 23° C. Two points of the optical fiber were fixed with two chuck devices, a portion of the coating resin layer (primary resin layer and secondary resin layer) between the two chuck devices was removed, and then, one of the chuck devices was fixed and the other chuck device was slowly moved in the opposite direction of the fixed chuck devices. When a length of the portion of the optical fiber sandwiched between the chuck devices to be moved is L, an amount of movement of the chuck device is Z, an outer diameter of the primary resin layer is Dp, an outer diameter of the glass fiber is Df, a Poisson's ratio of the primary resin layer is n, and a load during movement of the chuck devices is W, the Young's modulus of the primary resin layer was determined from the following formula.

$$Young ' s modulus ( MPa ) = ( ( 1 + n ) W / π LZ ) \times ln ( Dp / Df )$$

### (Young's Modulus of Secondary Resin Layer)

The Young's modulus of the secondary resin layer was determined from the 2.5% secant value obtained by performing a tensile test (gauge length: 25 mm) at 23° C. using a pipe-shaped coating resin layer (with a length of 50 mm or more) obtained by removing a glass portion from an optical fiber. The Young's modulus of the secondary resin layer was 1000 MPa.

### (Content of Organic Base)

A content of the organic base contained in the coating resin layer was determined by the following procedure using a gas chromatography apparatus (trade name “GC-2010” manufactured by Shimadzu Corporation). First, a calibration curve was prepared using an ethanol standard solution of each organic base. Next, the optical fiber 0.5 g was placed in a vessel, ethanol 5 mL was added, the vessel was covered with a lid, and ultrasonic waves were applied for 60 minutes to obtain an extraction liquid. The measurement was performed using UA-1 (thickness: 0.25 μm, internal diameter: 0.25 mm, length: 30 m) manufactured by Frontier Laboratories Ltd. as a column at column temperatures of 100° C. (20° C./min)→160° C. (5° C./min)→230° C. (60° C./min)→350° C. (held for 15 minutes). The content of the organic base contained in the coating resin layer was calculated by quantifying the amount of the organic base contained in the extraction liquid using FID as a detector.

### (Hot Water Test)

The transmission loss of light having a wavelength of 1.55 μm through the optical fiber was measured by an optical time domain reflectometer (OTDR) method. Next, the optical fiber was immersed in hot water at 60° C. for 60 days, and then the transmission loss of light having the wavelength of 1.55 μm was measured. A case where the difference between the transmission loss before immersion in hot water and the transmission loss after immersion in hot water for 60 days was 0.05 dB/km or less was evaluated as “A”, and a case where the difference was more than 0.05 dB/km was evaluated as “B”.

### (Glass Strength)

A bundle of optical fibers was immersed in hot water at 85° C. for 60 days, and the glass strength before and after immersion was evaluated. The glass strength was evaluated to be good or poor by measuring 50% strength. The 50% strength is a strength at which half of the optical fibers to be tested are broken in a tensile test of the optical fibers. In this test example, the tensile test was performed on each optical fiber to be tested at tensile speed of 25 mm/min. With respect to the 50% strength value of the glass strength before immersion, a case where the 50% strength value of the glass strength after immersion was smaller than 80% was evaluated as “C”, a case where the 50% strength value of the glass strength after immersion was 80 to 90% was evaluated as “B”, and a case where the 50% strength value of the glass strength after immersion was larger than 90% was evaluated as “A”.

TABLE 1

| Test Example | | 1 | 2 | 3 | 4 | 5 | 6 |
|---|---|---|---|---|---|---|---|
| Photopolymerizable | Urethane acrylate | 50 | 50 | 50 | 50 | 50 | 50 |
| Compound | EO-NPA | 40 | 40 | 40 | 40 | 40 | 40 |
| (parts by mass) | 1,6-HAD | 8.0 | 8.0 | 8.0 | 8.0 | 8.4 | 7.5 |
| Silane Coupling Agent | MPTS | 0.5 | 0.5 | 0.5 | 0.5 | 0.5 | 0.5 |
| (parts by mass) | TEOS | — | — | — | — | — | 0.5 |
| Photopolymerization | TPO | 1 | 1 | 1 | 1 | 1 | 1 |
| Initiator | | | | | | | |
| (parts by mass) | | | | | | | |
| Organic Base | ε-Caprolactam | 5000 | — | — | — | — | 5000 |
| (ppm) | δ-Valerolactam | — | 5000 | — | — | — | — |
| | Benzylamine | — | — | 5000 | — | — | — |
| | Aniline | — | — | — | 5000 | — | — |
| | Pyridine | — | — | — | — | 1000 | — |

| | | | | | | |
|---|---|---|---|---|---|---|
| Young's Modulus of | 0.5 | 0.5 | 0.5 | 0.5 | 0.5 | 0.5 |
| Primary Resin Layer (MPa) | | | | | | |
| Hot Water Test | A | A | A | A | A | A |
| Glass Strength | A | A | A | A | A | A |

TABLE 2

| Test Example | | 7 | 8 | 9 | 10 | 11 |
|---|---|---|---|---|---|---|
| Photopolymerizable | Urethan acrylate | 50 | 50 | 50 | 50 | 50 |
| Compound | EO-NPA | 40 | 40 | 40 | 40 | 40 |
| (parts by mass) | 1,6-HAD | 8.5 | 8.4 | 7.7 | 7.5 | 8.5 |
| Silane Coupling Agent | MPTS | 0.5 | 0.5 | 0.5 | 0.5 | 0.5 |
| (parts by mass) | TEOS | — | — | — | — | — |
| Photopolymerization | TPO | 1 | 1 | 1 | 1 | 1 |
| Initiator | | | | | | |
| (parts by mass) | | | | | | |
| Organic Base | ε-Caprolactam | 10 | 1000 | 8000 | 10000 | 1 |
| (ppm) | | | | | | |

| | | | | | |
|---|---|---|---|---|---|
| Young's Modulus of | 0.5 | 0.5 | 0.5 | 0.5 | 0.5 |
| Primary Resin Layer (MPa) | | | | | |
| Hot Water Test | A | A | A | A | B |
| Glass Strength | A | A | B | C | A |

### REFERENCE SIGNS LIST

10, 10A: optical fiber
11: core
12: cladding
13: glass fiber
14: primary resin layer
15: secondary resin layer
16: coating resin layer
121: inner cladding
122: trench
123: outer cladding

What is claimed is:

1. An optical fiber comprising:
a glass fiber including a core and a cladding; and
a coating resin layer being in contact with the glass fiber and coating the glass fiber,
wherein the coating resin layer includes a primary resin layer coating the glass fiber and a secondary resin layer coating the primary resin layer,
the primary resin layer includes a cured product of a resin composition containing a photopolymerization initiator, a silane coupling agent, an organic base, and a photopolymerizable compound including urethane (meth)acrylate, and
a content of the organic base is 5 ppm or more and 9000 ppm or less with respect to a total amount of the coating resin layer.

2. The optical fiber according to claim 1, wherein the organic base is at least one selected from the group consisting of an aromatic amine, an aliphatic amine having an aromatic ring, a heterocyclic amine, and a cyclic amide.

3. The optical fiber according to claim 2, wherein the cyclic amide is δ-valerolactam or ε-caprolactam.

4. The optical fiber according to claim 1, wherein the resin composition contains two or more silane coupling agents.

5. The optical fiber according to claim 1, wherein the primary resin layer has a Young's modulus of 0.6 MPa or less at 23° C.

6. The optical fiber according to claim 2, wherein the resin composition contains two or more silane coupling agents.

7. The optical fiber according to claim 3, wherein the resin composition contains two or more silane coupling agents.

8. The optical fiber according to claim 2, wherein the primary resin layer has a Young's modulus of 0.6 MPa or less at 23° C.

9. The optical fiber according to claim 3, wherein the primary resin layer has a Young's modulus of 0.6 MPa or less at 23° C.

10. The optical fiber according to claim 4, wherein the primary resin layer has a Young's modulus of 0.6 MPa or less at 23° C.
